(19) United States
(12) Patent Application Publication
(10) Pub. No.: US 2019/0350229 A1
(43) Pub. Date: Nov. 21, 2019

(54) FOOD PRODUCTS AND FOOD PRODUCT CARRIERS FOR ELECTROMAGNETIC WAVE FOOD PROCESSING SYSTEMS AND METHODS

(71) Applicant: Campbell Soup Company, Camden, NJ (US)

(72) Inventor: Mark Robert Watts, Marlton, NJ (US)

(21) Appl. No.: 16/412,860

(22) Filed: May 15, 2019

Related U.S. Application Data
(60) Provisional application No. 62/673,177, filed on May 18, 2018.

(51) Int. Cl. A23L 3/01; B65B 55/14; A23L 3/10; B65D 81/34; H05B 6/64

(52) U.S. Cl. CPC A23L 3/01; B65B 55/14; A23V 2002/00; B65D 81/3461; H05B 6/6408; A23L 3/10

(57) ABSTRACT

Embodiments herein relate to food products and food product carriers for electromagnetic wave food processing systems and methods. In an embodiment, a carrier for holding food products during a sterilization or pasteurization process is included. The carrier can include a lower housing portion defining a central peak and an upper housing portion configured to fit over the lower housing portion. The upper housing portion can define a central peak. The carrier can be configured to receive a flexible food package between the lower central peak and the upper central peak. Other embodiments are also included herein.

This application claims the benefit of U.S. Provisional Application No. 62/673,177, filed May 18, 2018, the content of which is herein incorporated by reference in its entirety.

### FIELD

Embodiments herein relate to food products and food product carriers for electromagnetic wave food processing systems and methods.

### BACKGROUND

Most food products tend to spoil relatively quickly. As such, preservation techniques have been developed over many years to extend the amount of time that a given food product will remain fresh. Food preservation techniques can include dehydrating, freezing, fermenting, pickling, acidification, curing, canning, heat treating, retort sterilization, irradiating, chemical preservation and the like.

Retort sterilization typically involves the application of heat to hermetically sealed packages of food through thermal conduction. Retort sterilization allows for packaged non-frozen and non-dehydrated ready-to-eat foods that can have a shelf life of months to years.

While food preservation techniques, such as retort sterilization, have been successful at preventing food spoilage, it has been found that such techniques can have adverse effects on food products including, diminishing taste and appearance, reducing nutritional qualities, and the like.

Another approach to sterilization and/or pasteurization has been the application of electromagnetic wave energy (such as microwave or radiofrequency wave energy). However, the use of electromagnetic wave energy for sterilization and/or pasteurization at commercial scale has proven difficult.

### SUMMARY

Embodiments herein include food products and food product carriers for electromagnetic wave food processing systems and related methods. In an embodiment, a carrier for holding food products during a sterilization or pasteurization process is included. The carrier can include a housing defining a peak and configured to receive a flexible food package such that the peak pushes into the flexible food package distorting the shape of the flexible food package. The housing can be formed of a microwave and radiofrequency transparent material.

In an embodiment, a carrier for holding food products during a sterilization or pasteurization process is included. The carrier can include a lower housing portion defining a central peak and an upper housing portion configured to fit over the lower housing portion. The upper housing portion can define a central peak. The carrier can be configured to receive a flexible food package between the lower central peak and the upper central peak.

In an embodiment, a carrier for holding food products during a sterilization or pasteurization process is included. The carrier can include a lower housing portion defining a lower half-toroidal channel and an upper housing portion configured to fit over the lower housing portion, the upper housing portion defining an upper half-toroidal channel.

In an embodiment, a method of making a food product is included. The method can include disposing a food material within a flexible food package, sealing the flexible food package, distorting the shape of the flexible food package to assume a shape that is more toroidal than its starting shape, and applying electromagnetic wave energy to the food material.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following drawings, in which:

FIG. 1 is a schematic view of a packaged food item in accordance with various embodiments herein.

FIG. 2 is a cross-sectional view of a packaged food item as taken along line 2-2′ in accordance with various embodiments herein.

FIG. 3 is a cross-sectional view of a packaged food item as taken along line 3-3′ in accordance with various embodiments herein.

FIG. 4 is a schematic view of a food product within a carrier being processing with electromagnetic wave energy in accordance with various embodiments herein.

FIG. 5 is a schematic view of a packaged food item in accordance with various embodiments herein.

FIG. 6 is a cross-sectional view of a packaged food item in accordance with various embodiments herein.

FIG. 7 is a cross-sectional view of a packaged food item in accordance with various embodiments herein.

FIG. 8 is a schematic view of a press member in accordance with various embodiments herein.

FIG. 9 is a schematic view of a press member in accordance with various embodiments herein.

FIG. 10 is a schematic view of a press member in accordance with various embodiments herein.

FIG. 11 is a schematic view of a food product carrier in accordance with various embodiments herein.

FIG. 12 is a cross-sectional view of a press member in accordance with various embodiments herein.

FIG. 13 is a schematic view of a press member in accordance with various embodiments herein.

FIG. 14 is a schematic view of a press member in accordance with various embodiments herein.

While embodiments are susceptible to various modifications and alternative forms, specifics thereof have been shown by way of example and drawings, and will be described in detail. It should be understood, however, that the scope herein is not limited to the particular embodiments described. On the contrary, the intention is to cover modifications, equivalents, and alternatives falling within the spirit and scope herein.

### DETAILED DESCRIPTION

Microwave heating of packaged food products can create conditions of uneven heating inside the packaging. Some of this can be attributed to the dielectric properties of the product being heated, the geometry of the package, and the penetration depth of the microwave itself into the product.

Package geometry is highly significant. By way of example, sharp corners on a package can become “hot spots” under microwave load (an edge effect of small mass in a powerful energy field). However, in accordance with embodiments herein, geometry can be controlled to reduce uneven heating inside the packaging.

An ideal design for microwave heating is a toroidal “donut” shape, which presents a solution to heating from both the outside and inside product surfaces, and with no sharp angles. The surface of a toroidal shape tends to heat evenly in a microwave field without zones of preferential heating. The shaping results in minimizing hot and cold spots and also minimizing unnecessary overheating to assure sterility in cold spots or zones. Unfortunately, it is difficult to design packaging in a toroidal shape. Further, a toroidal shape is generally not conducive to consumer functionality and convenience cannot.

However, in accordance with various embodiments herein, a package carrier can be used to temporarily distort packaging into a more toroidal shape such that it can be processed with a microwave or RF field while in a generally toroidal shape and then released from the package carrier to reassume its normal shape. For example, a package carrier including a press element or press plate can deflect the central portion of a pouch, narrowing the distance to the mid-point from top and bottom and causing it to assume a more toroidal shape.

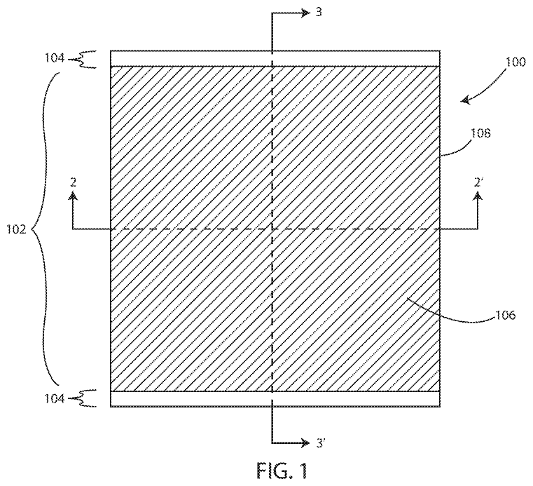

Referring now to FIG. 1, a schematic view of a packaged food product 100 including a flexible food package 108 is shown in accordance with various embodiments herein. The flexible food package 108 can include a seal zone 104 and a food material containing zone 102. A food material 106 can be disposed within the flexible food package 108 within the food material containing zone 102. The flexible food package can be formed of various materials, examples of which are described in greater detail below.

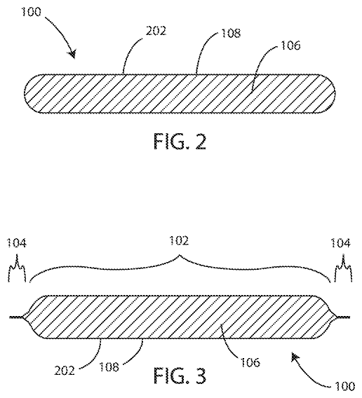

Also, the flexible food package can be of various sizes. In some embodiments, the flexible food package can specifically be a pouch, but other form factors are also contemplated herein. In some embodiments the flexible food package can have a height (such as along the axis referenced by line 3-3′) of about 2 inches to 14 inches. In some embodiments, the flexible food package can have a width (such as along the axis referenced by line 2-2′) of about 2 inches to 12 inches. In some embodiments, the flexible food package can have a thickness (shown in the cross-sectional views in FIGS. 2 and 3) of about 0.1 inches to 3 inches. In various embodiments, the ratio of the height to width (or aspect ratio) can be from about 5:1 to 1:5. In various embodiments, the ratio of the height to thickness can be from about 50:1 to about 3:1.

Referring now to FIG. 2, a cross-sectional view of a packaged food product 100 is shown as taken along line 2-2′ of FIG. 1. The packaged food product 100 includes a flexible food package 108 formed of a packaging material layer 202. The flexible food package 108 defines an interior volume in which a food material 106 is disposed. It will be appreciated that flexible food packages can be sized to contain various amounts of food materials. In some embodiments, the flexible food package can have a nominal interior volume of about 100 ml, 150 ml, 200 ml, 250 ml, 300 ml, 350 ml, 400 ml, 500 ml, 750 ml, 1000 ml, 1500 ml, or 2000 ml, or can have a nominal interior volume falling within a range between any of the foregoing.

Referring now to FIG. 3, a cross-sectional view is shown of a packaged food product 100 as taken along line 3-3′ of FIG. 1. FIG. 3 shows a flexible food package 108 formed of a packaging material layer 202. The flexible food package 108 includes a seal zone 104 and a food material containing zone 102 that defines an interior volume in which a food material 106 is disposed. In some embodiments the seal zone 104 can be formed through a thermal sealing process. In some embodiments the seal zone 104 can be formed through an adhesive based sealing process. It will be appreciated that embodiments herein also include those with flexible food packages without seal zones.

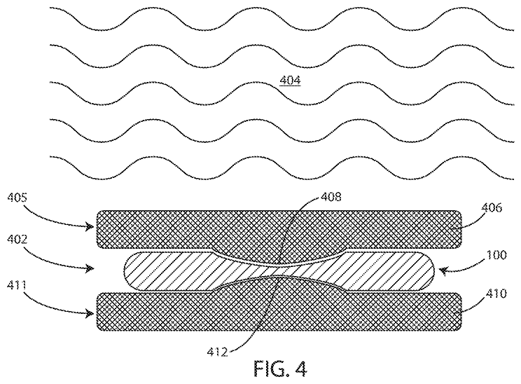

Referring now to FIG. 4, a schematic view is shown of a packaged food product 100 within a carrier 402 (or food product carrier) being processing with electromagnetic wave energy 404. The carrier 402 includes an upper press member 405 including a housing 406 defining a peak 408. The carrier 402 also includes a lower press member 411 including a housing 410 defining a peak 412. In some embodiments, peak 408 and peak 412 can be rounded peaks. Peak 408 and peak 412 can be positioned to align with a central portion of the packaged food product 100. The packaged food product 100 is sandwiched between the upper press member 405 and the lower press member 411. The peaks 408, 412 cause the packaged food product 100 to deform in the middle and, specifically, narrow in the middle resulting in the packaged food product 100 assuming a shape that is more toroidal than the shape illustrated in FIGS. 2 and 3. In this view, electromagnetic wave energy 404 is shown being applied to the carrier 402 with the food product disposed therein.

Electromagnetic wave energy can include energy at various frequencies. For example, electromagnetic wave energy can be applied at a frequency from approximately 300 MHz to approximately 2550 MHz or between 800 MHz to approximately 2550 MHz. In some embodiments, electromagnetic wave energy can be applied at a frequency of about 915 MHz or about 2450 Mhz. In some embodiments, electromagnetic wave energy can be applied at a frequency of about 13.56 MHz to 300 MHz.

The housings of the press members can be solid, hollow, or partially hollow (e.g. 5, 10, 20, 30, 40, 50, 60, 70, 80, 90, 95, 98, or 99 volume % hollow, or an amount falling within a range between any of the foregoing). The housing can be formed of a material that is substantially transparent to electromagnetic wave energy and specifically transparent to microwave and radiofrequency wave energy. Exemplary materials that can be used to form the housings can include, but are not limited to, materials with low dielectric loss characteristics. Exemplary materials can specifically include, but are not limited to, glass (such as borosilicate glass), polymers (including, but not limited to, polyethylene, polypropylene, polycarbonate, and polytetrafluoroethylene), ceramics, composites (including, but not limited to, composites including carbon and/or glass fibers) and the like.

Referring now to FIG. 5, a schematic view is shown of a packaged food product 100 including a flexible food package 108 is shown in accordance with various embodiments herein. For the benefit of illustration, the flexible food package 108 is shown as divided into a first lateral segment 502, a second lateral (or lateral middle) segment 504, and a third lateral segment 506. In this illustration, the three lateral segments each include approximately 33.3% of the package width, however, it will be appreciated that the flexible food package could also be divided for purposes of analysis into a greater or lesser number of equal segments (e.g., 2, 3, 4, 5, 6, 7, 8, 9, 10, etc. segments). Further, the flexible food package 108 is shown as divided into a first vertical segment 508, a second vertical segment 510, and a third vertical segment 512. Again, in this illustration, the three vertical segments each include approximately 33.3% of the package height, however, it will be appreciated that the flexible food package could also be divided for purposes of analysis into a greater or lesser number of equal segments (e.g., 2, 3, 4, 5, 6, 7, 8, 9, 10, etc. segments). The intersection of the second lateral segment 504 and the second vertical segment 510 defines a center portion 514.

In accordance with various embodiments herein, the volume of food material in the center portion 514 and/or in places representing the intersection of center or central lateral and vertical segments can be decreased through distortion of the package shape resulting from press members of a food package carrier pushing into the food package. The food material previously in the center portion 514 can be displaced and pushed into segments of the food package surrounding the center portion 514 and in so doing the mass of food material assumes a shape that is more toroidal than the configuration in which it started. In the context of a package assessed based on three lateral segments and three vertical segments, the decrease of food material in the center portion 514 by weight can be at least about 10, 15, 20, 30, 40, 50, 60, 70, 80, 90, 95, 98 or 99 percent, or can be an amount falling within a range between any of the foregoing. By definition, the amount of the increase of food material in the other areas, in the aggregate, is equal to the decrease in the center portion 514.

In some embodiments, the food material containing zone 102 (see FIG. 1) can have rounded corners 572, so as to minimize areas with less product mass in a small area that may otherwise be more likely to overheat. The rounded corners can have a radius of curvature from about 5 mm to about 100 mm.

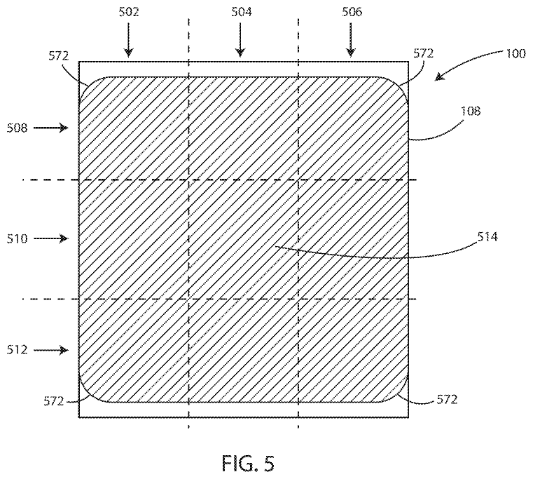

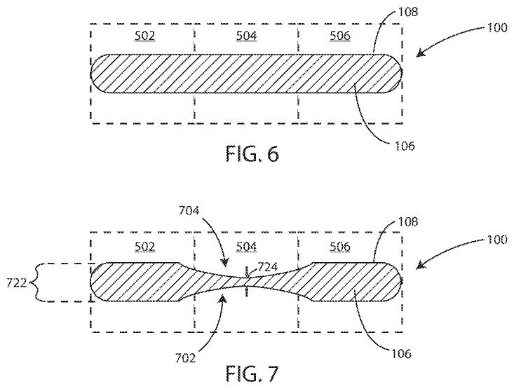

Referring now to FIG. 6, a cross-sectional view of a packaged food product 100 is shown similar to that shown in FIG. 2. FIG. 6 represents a packaged food product 100 in its initial state before the shape of the flexible food package 108 has been distorted and before food material 106 has been displaced from one area and moved into another area. In this view, the packaged food product 100 includes a first lateral segment 502, a second lateral segment 504, and a third lateral segment 506.

Referring now to FIG. 7, a cross-sectional view of a packaged food product 100 is shown similar to that shown in FIG. 2. FIG. 7 represents a packaged food product 100 after the shape of the flexible food package 108 has been distorted and therefore after food material 106 has been displaced from one area and moved into another area. In this view, the packaged food product 100 includes a first lateral segment 502, a second lateral segment 504, and a third lateral segment 506. In this view, there is shape distortion 702 on the bottom side of the packaged food product 100 as well as shape distortion 704 on the top side of the packaged food product 100.

FIG. 7 illustrates a minimum product thickness 724 in the central area and a maximum product thickness 722 in the areas of the product surrounding the central area. In some embodiments, the ratio of the central minimum thickness to the surrounding maximum thickness can be about 1:1.5, 1:2, 1:4, 1:8, 1:12, 1:25, 1:50, 1:75 or about 1:100, or the ratio can fall within a range between any of the forgoing. In some embodiments, the central minimum thickness is equal to or less than 80, 70, 60, 50, 40, 30, 20, 10 or 5% of the surrounding maximum thickness.

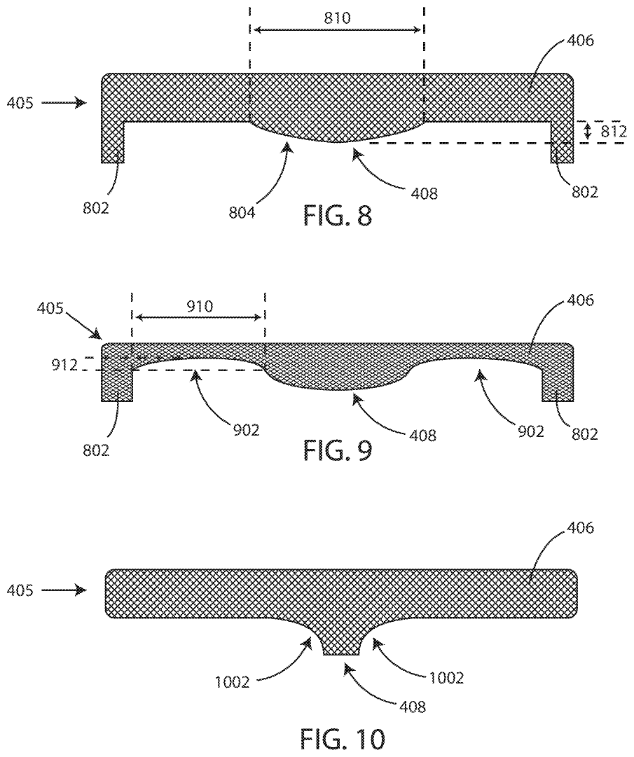

It will be appreciated that press members and features thereof, including but not limited to the peak, can have various shapes, contours, and sizes. Referring now to FIG. 8, a schematic view of a press member 405 is shown in accordance with various embodiments herein. The press member 405 includes a housing 406 can define a peak 408 which can have a convex surface 804. The housing 406 can further define a raised outer rim 802 disposed on both ends of the housing 406. In some embodiment, the raised outer rim 802 can be sufficiently large so as to help hold a package food product in the proper position with the food package carrier.

The peak 408 can have a width 810 and a height 812. The width 810 can be about 0.5, 0.75, 1, 1.5, 2, 2.5, 3, 3.5 or 4 inches, or can fall within a range between any of the foregoing. The height 812 can be about 0.1, 0.2, 0.3, 0.4, 0.5, 0.6, 0.7, 0.8, 1, 1.5, 2 or 3 inches, or can fall within a range between any of the foregoing.

Many different contours and structural features are contemplated herein, at least some of which can be configured to aid in causing a packaged food product in assuming a more toroidal shape. Referring now to FIG. 9, a schematic view of a press member 405 is shown in accordance with various embodiments herein. The press member 405 includes a housing 406 which can define a peak 408. The peak 408 can have a convex surface 804. The housing 406 can further define depressions 902 disposed on both sides of the peak 408. The housing 406 can further define a raised outer rim 802 disposed on both ends of the housing 406.

The depressions 902 can provide for an area into which the food package can expand as pressure is applied using a press element with a peak pushing into a central area of the food package. The depressions 902 can surround the peak 408 such that they form a circular or ring-like channel around the peak 408. In some embodiments, the depressions 902 can define a half-toroidal shape. The depressions 902 can have various depths and widths. In some embodiments the depressions 902 can have a depth 912 of 0.1, 0.2, 0.3, 0.4, 0.5, 0.8, 1 or 1.5 inches, or can have a depth 912 falling within a range between any of the foregoing. In some embodiments the depressions 902 can have a width 910 of about 0.3, 0.4, 0.5, 0.8, 1, 2, 3 or 4 inches, or can have a width falling within a range between any of the foregoing.

It will be appreciated that the peaks can take on various different shapes. Referring now to FIG. 10, a schematic view is shown of a press member 405. The press member 405 can include a housing 406. In this example, the housing 406 includes a peak 408 which includes a concave portion 1002 on both sides of the peak 408. While not intending to be bound by theory, it is believed that in some embodiments the use of a peak with concave portions can aid in causing the food material to assume a more toroidal shape.

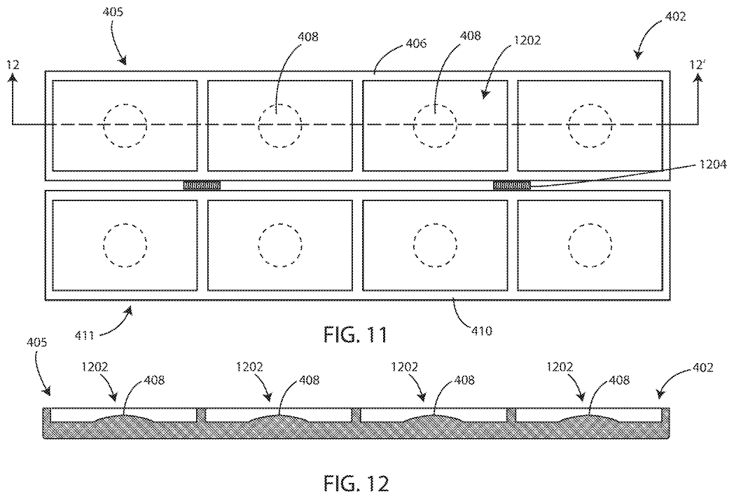

It will be appreciated that food product carriers herein can include spots to hold and deform multiple food packages. Referring now to FIG. 11, a schematic view of a food product carrier 402 is shown in accordance with various embodiments herein. The food product carrier 402 includes an upper press member 405 including a housing 406 and a lower press member 411 including a housing 410. The food product carrier 402 can include a plurality of package receiving areas 1202. Each package receiving area 1202 can include at least one peak 408. Carriers with various numbers of package receiving areas 1202 are specifically contemplated herein such as 1, 2, 3, 4, 5, 6, 7, 8, 9, 10, 15, 20, 30 or 40, or a number of package receiving areas 1202 falling within a range between any of the foregoing.

The upper housing 406 and the lower housing 410 can be attached to one another in a manner to allow them to pivot with respect to one another in order to close around a plurality of food packages disposed therein. In some embodiments, the upper housing 406 and the lower housing 410 can be connected to one another with a hinge mechanism 1204. In some embodiments, the upper housing 406 and the lower housing 410 can be connected to one another using an element other than a hinge mechanism. However, in other embodiments, the upper housing 406 and the lower housing 410 can be configured to simply be set on top of one another and not specifically connected to one another. In some embodiments, the upper housing 406 and the lower housing 410 can be secured together with a latch or other mechanical element.

Referring now to FIG. 12, a cross-sectional view is shown of a food product carrier 402 as taken along line 12-12′ of FIG. 11. In this view, the carrier 402 defines a plurality of package receiving areas 1202. Each package receiving area 1202 can include at least one peak 408.

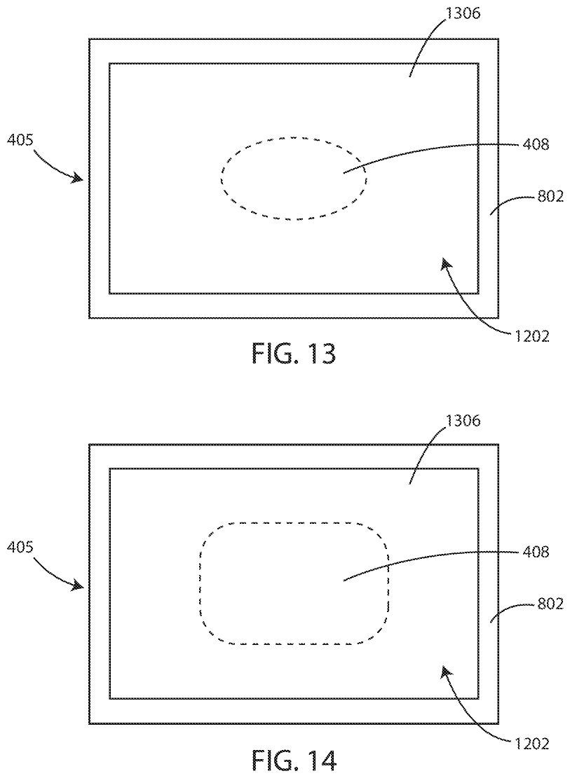

It will be appreciated that the peaks associated with press members herein can take on various shapes. Referring now to FIG. 13, a schematic view of a portion of a press member 405 is shown in accordance with various embodiments herein. The press member 405 includes a housing 1306 defines a package receiving area 1202 bordered by a raised outer rim 802. The housing 1306 further defines a peak 408 within a central portion of the package receiving area 1202. In this view, the peak 408 has an oval or ovoid shape. However, the peak 408 can also take on various other shapes. In some embodiments, the peak 408 has a shape with cross-section having two or more lines of symmetry.

Referring now to FIG. 14, a schematic view of a portion of a press member 405 is shown in accordance with various embodiments herein. The press member 405 includes a housing 1306 defines a package receiving area 1202 bordered by a raised outer rim 802. The housing 1306 further defines a peak 408 within a central portion of the package receiving area 1202. In this view, the peak 408 has a generally rectangular or rounded rectangular shape. However, as shown in previous figures the peak can also be circular. In some embodiments, the peak can have a polygonal shape. In some embodiments, the peak can have an irregular shape.

### Thermal Consistency

As referenced above, the shaping of packages herein (temporary or permanent) results in minimizing hot and cold spots and also minimizing unnecessary overheating to assure sterility in cold spots or zones. In various embodiments herein, all portions of a food material can be brought to a specific minimum temperature for a specific amount of time with no portions or no more than a defined small portion exceeding a threshold temperature (over temperature). The threshold temperature can be either a specific temperature (absolute) or a defined number of degrees above the specific minimum temperature (relative).

In various embodiments, the specific minimum temperature can be about 165, 170, 175, 180, 185, 190, 195, 200, 205, 210, or 212 degrees Fahrenheit, or can fall within a range between any of the foregoing. The specific amount of time can be about 15 seconds, 30 seconds, 1 minute, 2 minutes, 3 minutes, 4 minutes, 5 minutes, 7.5 minutes, 10 minutes, 15 minutes, 20 minutes, 25 minutes, or 20 minutes, or an amount of time that can fall within a range between any of the foregoing.

In various embodiments, the threshold temperature (over temperature) as an absolute value can be about 180, 185, 190, 195, 200, 205, 210, or 212 degrees Fahrenheit, or can fall within a range between any of the foregoing. In various embodiments, the threshold temperature (over temperature) as a relative value can be about 10, 15, 20, 25, 30, 35, 40, or 50 degrees Fahrenheit, or can fall within a range between any of the foregoing.

In various embodiments, the defined small portion which exceeds the threshold temperature is less than about 30, 25, 20, 15, 10, 8, 6, 4, 2, or 1 percent of the total food material amount by weight, or can fall within a range between any of the foregoing.

Thermal consistency can be achieved while still providing thermal processing to achieve a desired level of microorganism inactivation. By way of example, in some embodiments, the food products can be sufficiently processed so as to achieve a 1 log, 2 log, 3 log, 4 log, 5 log, or 6 log reduction or greater in viable, vegetative microorganisms. In some embodiments the food products can be sufficiently processed so as to achieve a 1 log, 2 log, 3 log, 4 log, 5 log, or 6 log or greater reduction in microorganism spores. In some embodiments the food products can be sufficiently processed so as to achieve a 12 log reduction in spores, such as Clostridium botulinum. In some embodiments the food products can be sufficiently processed to achieve commercial pasteurization or commercial sterilization. The system can include a controller module and a controller program to calculate the total dosage of electromagnetic wave energy and determine if the prescribed lethality was achieved per station as well as total lethality.

### Methods

Various methods are included herein. In some embodiments, a method of manufacturing a food product is included. The method can include various operations, including those described above. As one example, the method can include an operation of placing a food material into a food package, such as a flexible pouch or other package. The method can also include an operation of sealing the food material into the food package, using thermal, adhesive, or other techniques. In the context of pouches, or other flexible food packages, the food product can be put into a food product carrier. The food product carrier can include a peak on one or two sides (e.g., top and bottom) that pushes into flexible the food package causing a distortion of the shape of the food package into a shape that is more toroidal than its starting shape. The method can also include an operation of applying electromagnetic wave based energy to the food package. In some embodiments, such as in the context of pouches or other flexible food packages, the method can also include an operation of returning the food package to its original shape.

### Packaging Materials

Pouches can be formed of various materials including, but not limited to monolayers, multilayer laminates, and the like. In various embodiments, the pouch material can be substantially transparent to microwave and/or radiofrequency radiation. In various embodiments, the pouch material can be substantially opaque to visible spectrum radiation. In some embodiments, pouches can include laminates of plastic and metal foil layers. Layers can include materials such as, but not limited to, polyesters, polyethylene terephthalate (crystallized or amorphous), polyamide (NYLON), oriented polyamide, bi-oriented polyamide, polycarbonate, polyetherimide, polyolefins such as polypropylene or polyethylene, ethylene vinyl alcohol, aluminum, aluminum oxide, or other metals, adhesive layers, and the like. Pouches can have material thicknesses of 1, 2, 3, 4, 5, 6, 7, 8, or 10 mils, or a thickness that can fall within a range between any of the foregoing thicknesses. In various embodiments, the pouch material is flexible. In various embodiments, the pouch material(s) can contain less than 0.01 wt. % metal content.

Sealing materials forming the sealing material layer (sometimes referred to as lidding materials) can be formed of various materials including, but not limited to, polyesters, polyethylene terephthalate (crystallized or amorphous), polyamide (NYLON), oriented polyamide, bi-oriented polyamide, polycarbonate, polyetherimide, polyolefins such as polypropylene or polyethylene, ethylene vinyl alcohol, aluminum, aluminum oxide, or other metals, adhesive layers, and the like. Sealing material layers can have material thicknesses of 0.5, 1, 2, 3, 4, 5, 6, 7, 8, or 10 mils, or a thickness that can fall within a range between any of the foregoing thicknesses. In various embodiments, the sealing material layer is flexible. In various embodiments, the material(s) of the sealing material layer can contain less than 0.01 wt. % metal content.

### Food Materials and Food Products

Food materials in accordance with embodiments herein can include, but are not limited to, foods of all types as well as drinks of all types, unless used explicitly to the contrary. Food materials herein can include shelf-stable food materials, extended shelf-life food materials, ready-to-eat food materials, chilled food materials, refrigerated food materials, and the like. Shelf-stable food materials/products include those where the material or product is free of microorganisms (pathogens and spoilage-causing microorganisms) capable of growing in the product at non-refrigerated conditions at which the product is intended to be held during distribution and storage. Food materials/products that can be safely stored at room temperature, or “on the shelf,” are called “shelf stable.”

Food materials herein can include acidified and non-acidified food materials. By way of example, food materials can include those having a pH of below 4.6 as well as food materials having a pH of 4.6 or higher. Food materials herein can include high nutritional density food materials. Food materials herein can include human food materials, pet food materials, geriatric food materials, food materials for at-risk populations, baby food materials, nutraceuticals, and the like. Food materials herein can include, but are not limited to, soups, soups with particulates, sauces, concentrates, condiments, salsas, dips, fruits, vegetables, nut products, grain products, pasta products, food components or ingredients, beverages of all types, dairy products, meat products, fish products, entrees, combinations of any of these, and the like. In some embodiments, food materials herein include those that remain in a flowable state after exposure to thermal energy used for sterilization and/or pasteurization. In some embodiments, food materials herein include those that can be deformed in shape, then thermally treated using electromagnetic waves, and then return to an original or default package shape.

As used herein, the term “food package” shall be synonymous with the term “food container”. Food packages/containers can include many different types including, but not limited to, jars, cans, bottles, bowls, trays, multi-pack packages, bags, sleeves, pouches, and the like. Food packages/containers can be rigid, semi-rigid, semi-flexible, or flexible. In various embodiments the food packages herein can be substantially transparent to microwave energy and/or radiofrequency wave energy.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

Aspects have been described with reference to various specific and preferred embodiments and techniques. However, it should be understood that many variations and modifications may be made while remaining within the spirit and scope herein. As such, the embodiments described herein are not intended to be exhaustive or to limit the invention to the precise forms disclosed in the following detailed description. Rather, the embodiments are chosen and described so that others skilled in the art can appreciate and understand the principles and practices.

1. A carrier for holding food products during a sterilization or pasteurization process comprising:
a housing defining a peak and configured to receive a flexible food package such that the peak pushes into the flexible food package distorting the shape of the flexible food package;
the housing comprising a microwave and radiofrequency transparent material.

2. The carrier of claim 1, the peak comprising a circular or ovoid cross-section.

3. The carrier of claim 1, the peak comprising a rounded peak.

4. The carrier of claim 1, the peak positioned to align with a central portion of the flexible food pouch.

5. The carrier of claim 1, the housing further comprising a depression surrounding the peak.

6. The carrier of claim 5, the depression defining a half-toroidal shape.

7. The carrier of claim 5, further comprising a raised outer rim surrounding the depression.

8. The carrier of claim 1, wherein the height of the peak is from 0.1 to 1.5 inches.

9. The carrier of claim 1, wherein distorting the shape of the flexible food package causes the flexible food package to have a thinner central portion and a thicker portion surrounding the central portion.

10. A carrier for holding food products during a sterilization or pasteurization process comprising:
a lower housing portion defining a central peak; and
an upper housing portion configured to fit over the lower housing portion; the upper housing portion defining a central peak;
the carrier configured to receive a flexible food package between the lower central peak and the upper central peak.

11. The carrier of claim 10, the central peaks of the lower housing portion and the upper housing portion comprising a circular or ovoid cross-section.

12. The carrier of claim 10, the central peaks of the lower housing portion and the upper housing portion comprising a rounded peak.

13. The carrier of claim 10, the central peaks of the lower housing portion and the upper housing portion positioned to align with a central portion of the flexible food pouch.

14. The carrier of claim 10, the lower and upper housing portions further comprising a half-toroidal depression surrounding the central peaks therein.

15. A method of making a food product comprising:
disposing a food material within a flexible food package;
sealing the flexible food package;
distorting the shape of the flexible food package to assume a shape that is more toroidal than its starting shape; and
applying electromagnetic wave energy to the food material.

16. The method of claim 15, wherein distorting the shape of the flexible food package comprises placing the flexible food package in a carrier.

17. The method of claim 16, the carrier comprising
a housing defining a peak and configured to receive the flexible food package such that the peak pushes into the flexible food package distorting the shape of the flexible food package;
the housing comprising a microwave and radiofrequency transparent material.

18. The method of claim 16, the carrier comprising
a lower housing portion defining a central peak; and
an upper housing portion configured to fit over the lower housing portion; the upper housing portion defining a central peak;
the carrier configured to receive the flexible food package between the lower central peak and the upper central peak.

19. The method of claim 16, the carrier comprising
a lower housing portion defining a lower half-toroidal channel; and
an upper housing portion configured to fit over the lower housing portion; the upper housing portion defining an upper half-toroidal channel.

20. The method of claim 15, further comprising returning the flexible food package to its original shape.
